(19) United States
(12) Patent Application Publication
(10) Pub. No.: US 2002/0076265 A1
(43) Pub. Date: Jun. 20, 2002

(54) Tie rod with application of polymer composite with fibers reinforcement

(75) Inventor: Walter Takeo Yagyu, Sao Bernardo Do Campo (BR)

Correspondence Address: Liniak, Berenato, Longacre & White, Ste. 240, 6550 Rock Spring Drive, Bethesda, MD, 20817, US

(73) Assignee: DANA INDUSTRIAL S/A

(21) Appl. No.: 10/020,275

(22) Filed: Dec. 18, 2001

(30) Foreign Application Priority Data
Dec. 18, 2000 (BR) PI 0006516-1

(51) Int. Cl. F16C 11/06

(52) U.S. Cl. 403/56

(57) ABSTRACT

A tie rod with application of polymer composite with fibers reinforcement, constituted by a stem that connects two ball joints, that in its turn are connected to its ends, the body of the ball pins of these ball joints being fixed to different parts or components of a mechanical system with the purpose of transmitting to them angular and rotational movements, supporting the strains that are concentrated thereon. The stem of these tie rods, that constructed based on polymer composite with fibers reinforcement diminish the final weight of the tie rod, increase their mechanical resistance, increase their resistance to fatigue and provide dimensional stability, resistance to corrosion and low concentration of strains. The tie rods may be of fixed length, when the ball joints are attached to their ends by chemical fixing, that due to the process of application, cure and drying assure the resistance required for the purpose to which they are intended, or, they may be of variable length, that are provided with threads at the ends of the stem, the same occurring in the ball joints boxes that are intended to be fixed therein, what allows the adjustment of their length, being the locking of the assembly assured by nuts provided in the threads of the stem that are tightened against the boxes of the ball joints.

### BACKGROUND OF THE INVENTION

1. Field of the Invention

This invention refers to a tie rod with application of polymer composite with fibers reinforcement, constituted by a stem that connects two ball joints with the function of fixing and transmitting movements and strains of other mechanical components for application in automotive vehicles.

2. Description of Related Art

Ball joints are composed, generally, of a box with a housing interior of cylindrical shape where is introduced a bearing of single or split type, that conforms a ball pin, wherein the set already assembled has the function of applying movements, both angular and rotational, between two pieces that are fixed, one in the ball joint box and other in the body of the ball pin, that projects itself through an opening provided in the ball joint box. The body of the ball pin is fixed to one piece or component of a mechanical system and the ball joint box is fixed in other piece or component of the same mechanical system, wherein the ball joint so fixed liberates the angular and rotational movement of both pieces around the ball of the joint, supporting the strains that are concentrated thereon.

The object of the present invention, as above mentioned, is constituted by a stem and two ball joints, that are fixed at their ends through the boxes, and, in this case, only the body of the ball pins of each joint is fixed to different pieces or components of the mechanical system, joining them and releasing both the angular and rotational movement between these two pieces, besides supporting the strains that are concentrated in this place. These tie rods may have two construction forms: fixed length, namely, fixed distance between the centers of the fixed ball pins, and variable length, namely, adjustable distance between the ball pins, wherein in this latter case they are provided with thread at the ends where the ball joints are connected and, the variation of the length of the same is provided by the desired adjustment in the threads provided at their ends. Having in mind the need of supporting strains transmitted by the pieces that are fixed to the pins of the ball joints provided in the ends of the stem, these tie rods, in the state of the art, have stems made of metallic material, such as steel, for example. The tie rods are fixed in the ball joints by welding, when the tie rod is of fixed length, or by thread, when it is of variable length.

It happens that the dynamics of the present technological development, mainly in the automotive sector, tends to require day by day, new technologies that assure a better quality, greater durability and lower cost, and, specifically, lighter weight, with the objective to improve gradually the weight/power ratio of the automotive vehicles, what is translated in lower power expenditure with obvious economic results. Because of this fact, the tie rods with stems of metallic material become components undesirable to the new developments, considering that to support strains these stems need to be resistant and the resistance associated to the metallic material utilized results in excessive weight, what counteracts the desired expectations.

### SUMMARY OF THE INVENTION

The present invention intends to solve the inconveniences of presenting a tie rod constituted by the application to the body of the stem of a material based on polymer composites with fibers reinforcement, in combination with components of metallic materials of the ball joints boxes.

In the fixed length tie rod, the union of the stem with the ball joints boxes provided in their ends is assured by chemical fixing that, due to the process of application, cure and drying, guarantee the mechanical resistance required for the application to which they are intended.

In the variable length tie rod, the union of the stem with the ball joints boxes is assured by thread in the body of the stem and in the ball joint box, being that the locking between the stem and the ball joint box is assured by nuts placed in the threads of the stems and that are tightened against the boxes of the ball joints guaranteeing the locking of the assembly. The technical effects arisen from this new construction are translated in the following advantages, as compared to the state of the art, that utilizes in the manufacture of the stems, steel or other types of materials: reduction in the final weight of the assembly, increase of the mechanical resistance, increase of the resistance to fatigue, dimensional stability, resistance to corrosion and low concentration of strains.

### BRIEF DESCRIPTION OF THE DRAWINGS

The attached drawings present preferred embodiments of the invention, in which:

FIG. 1 shows a fixed length tie rod, in partial longitudinal cross section, for visualization of its construction details; and

FIG. 2 shows a variable length tie rod, in longitudinal cross section, for visualization of its construction details.

### DETAILED DESCRIPTION OF PREFERRED EMBODIMENTS

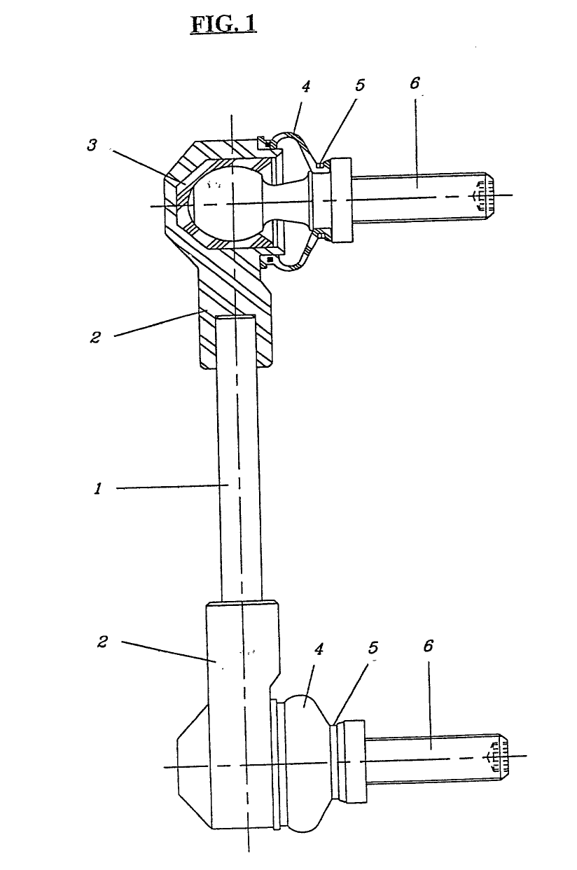

As it is shown in the attached drawings, the fixed length tie rod presented in FIG. 1 is composed by a stem 1 constructed with material based on polymer composite with fiber reinforcements, that present in their ends, fixed by chemical process, ball joints 2 that are composed of a bearing 3, a protection cover 4, a sealing ring 5 and a ball pin 6.

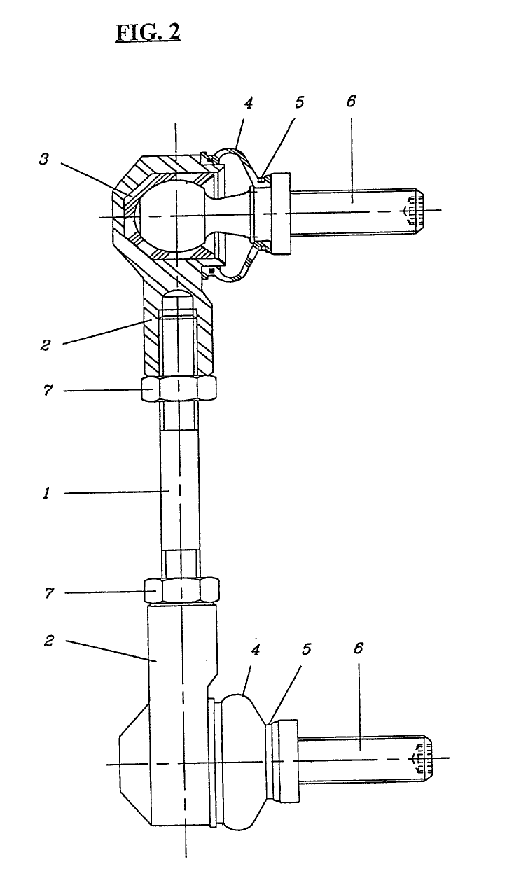

The variable length tie rod shown in FIG. 2 is composed by a stem 1, also constructed with material based on polymer composite with fibers reinforcement, that present at their ends, ball joints 2, composed by a bearing 3, a protection cover 4, a sealing ring 5 and a ball pin 6 being; however, these ball joints 2 fixed to the ends of the stem 1 by thread and nuts 7 that assure the adjustment of the length of the tie rod and the locking of the assembly.

From the foregoing description and drawings, it is clear that the present invention solves the inconveniences of presenting a tie rod constituted by the application to the body of the stem of a material based on polymer composites with fibers reinforcement, in combination with components of metallic materials of the ball joints boxes.

In the fixed length tie rod, the union of the stem with the ball joints boxes provided in their ends is assured by chemical fixing that, due to the process of application, cure and drying, guarantees the mechanical resistance required for the application to which they are intended.

In the variable length tie rod, the union of the stem with the ball joints boxes is assured by thread in the body of the stem and in the ball joint box, being that the locking between the stem and the ball joint box is assured by nuts placed in the threads of the stems and that are tightened against the boxes of the ball joints guaranteeing the locking of the assembly. The technical effects arisen from this new construction are translated in the following advantages, as compared to the state of the art, that utilizes in the manufacture of the stems, steel or other types of materials: reduction in the final weight of the assembly, increase of the mechanical resistance, increase of the resistance to fatigue, dimensional stability, resistance to corrosion and low concentration of strains.

While the foregoing invention has been shown and described with reference to a preferred embodiment, it will be understood by those of skill in the art that various changes in form and detail may be made therein without departing from the spirit and scope of the instant invention.

1. Tie rod with application of polymer composite with fibers reinforcement, comprising a stem provided at its ends with ball joints composed of a box, a bearing, a protection cover and a ball pin, said assembly having the function of fixing pieces and components of a mechanical system between themselves, providing to them angular and rotational movement, supporting the strains concentrated therein, wherein the stem of the tie rod is made of material comprising a polymer composite with fibers reinforcements, and combined with components of a metallic material provided in the ball joints.

2. Tie rod with application of polymer composite with fibers reinforcement, according to claim 1, wherein the ball joints are attached to the ends of the stem by chemical fixing that, due to the process of application, cure and drying, assure the resistance required to the objective to which they are intended, making the tie rod a tie rod with fixed length.

3. Tie rod with application of polymer composite with fibers reinforcement, according to claim 1, wherein the ball joints are attached to the ends of the stem by means of a thread in the body of the stem and in the ball joints boxes, making the tie rod a tie rod with variable length, the adjustment of its length and the locking of the assembly being provided by nuts provided in the threads of the stem and that are tightened against the boxes of the ball joints.
